(19) United States
(12) Patent Application Publication
(10) Pub. No.: US 2026/0200292 A1
(43) Pub. Date: Jul. 16, 2026

(54) VEHICULAR HEAT CYCLE APPARATUS AND METHOD OF ASCERTAINING REFRIGERANT CHARGE STATE USING THE SAME

(71) Applicant: Valeo Systemes Thermiques, Le Mesnil-Saint-Denis (FR)

(72) Inventors: Ryo Miyakoshi, Saitama (JP); Teruaki Tsuji, Saitama (JP)

(73) Assignee: Valeo Systemes Thermiques, Le Mesnil-Saint-Denis (FR)

(21) Appl. No.: 19/136,182

(22) PCT Filed: Dec. 5, 2023
(86) PCT No.: PCT/EP2023/084342

§ 371 Date: Jun. 5, 2025

(30) Foreign Application Priority Data
Dec. 5, 2022 (JP) 2022-193890

(51) Int. Cl. B60H 1/32; B60H 1/00

(52) U.S. Cl. CPC B60H 1/3227; B60H 1/00807; B60H 1/00828; B60H 1/00885

(57) ABSTRACT

A vehicular heat cycle apparatus and a method of ascertaining a refrigerant charge state to appropriately grasp insufficiency of a refrigerant in a refrigerant cycle even in an environment where an outside air temperature is low. The vehicular heat cycle apparatus includes a refrigerant cycle and a heat medium cycle. The heat medium cycle is thermally coupled to the refrigerant cycle. When it is determined that an outside air temperature is lower than a predetermined outside air temperature, a determination operation mode is switched to where an expansion valve is made fully open, and a compressor, a pump, and a heat medium heating device are operated. Thereafter, when a refrigerant temperature exceeds a first predetermined refrigerant temperature, it is determined whether the refrigerant temperature and a refrigerant pressure is lower than a pressure obtained by subtracting a predetermined pressure difference from a saturated vapor pressure curve of the refrigerant.

### TECHNICAL FIELD

The present invention relates to a heat cycle apparatus mounted in a vehicle and a method of ascertaining a refrigerant charge state using the same and, in particular, relates to a useful technique for detecting the refrigerant charge state when outside air has a low temperature.

### BACKGROUND ART

In related art, as a vehicular heat cycle apparatus, which is a combination of a refrigerant cycle (heat pump cycle) for circulating a refrigerant and a heat medium cycle for circulating a heat medium, an apparatus disclosed in PTL 1 below has been publicly known.

This apparatus includes:
a refrigerant cycle (heat pump cycle 10) including: a compressor (compressor 11) for compressing a refrigerant; a refrigerant and heat-medium heat exchanger (high-temperature-side water and refrigerant heat exchanger 12) for exchanging heat between the high-pressure refrigerant discharged from the compressor and a heat medium; an expansion valve (heating expansion valve 13) for depressurizing the refrigerant that has flowed out of the refrigerant and heat-medium heat exchanger; and a heat-absorption heat exchanger (external heat exchanger 14) into which the refrigerant that has passed through the expansion valve flows; and
a heat medium cycle (high-pressure-side heat medium circulation circuit 21) including: a pump (high-temperature-side water pump 21a) for circulating the heat medium; and a heat-dissipation heat exchanger (heater core 23) into which the heat medium that has been sent out of the pump flows so as to allow the heat medium to dissipate heat, the heat medium cycle being thermally coupled to the refrigerant cycle (heat pump cycle 10) with the refrigerant and heat-medium heat exchanger (high-temperature-side water and refrigerant heat exchanger 12).

In such a vehicular heat cycle apparatus, when a temperature of outside air becomes so low that a heating operation mode is set, the compressor (compressor 11) of the refrigerant cycle is operated, and also, the pump (high-temperature-side water pump 21a) of the heat medium cycle is operated. Then, in the refrigerant cycle, a heat pump cycle is composed in which the refrigerant circulates via the following in this order: the compressor (compressor 11), a refrigerant passage of the refrigerant and heat-medium heat exchanger (high-temperature-side water and refrigerant heat exchanger 12), the expansion valve (heating expansion valve 13), the heat-absorption heat exchanger (external heat exchanger 14), and the compressor (compressor 11). Moreover, in the heat medium cycle, a heat medium circulation circuit is composed in which the heat medium circulates via the following in this order: the pump (high-temperature-side water pump 21a), a heat medium passage of the refrigerant and heat-medium heat exchanger (high-temperature-side water and refrigerant heat exchanger 12), the heat-dissipation heat exchanger (heater core 23), and the pump (high-temperature-side water pump 21a).

Thus, in the heating operation mode, heat of the high-temperature and high-pressure refrigerant that has been discharged from the compressor (compressor 11) in the refrigerant cycle is transmitted to the heat medium via the refrigerant and heat-medium heat exchanger (high-temperature-side water and refrigerant heat exchanger 12) where the heat medium is heated, and the heat medium thus heated is supplied to the heat-dissipation heat exchanger (heater core 23), so that air passing through the heat-dissipation heat exchanger can be heated.

### CITATION LIST

### Patent Literature

### [PTL 1]

Japanese Unexamined Patent Application Publication No. 2015-101180

### SUMMARY OF INVENTION

### Technical Problem

In this manner, in the above-described vehicular heat cycle apparatus, there is a demand for operating the refrigerant cycle even in an environment where outside air has such a low temperature that a heating operation is needed. Therefore, from a viewpoint of protecting the compressor, there is need to make it possible to appropriately grasp a charge state of the refrigerant in the refrigerant cycle (heat pump cycle 10) even when the outside air has such a low temperature.

The charge state of the refrigerant in the refrigerant cycle can be grasped by detecting the temperature and pressure of the refrigerant in the cycle in a state in which the pressure in the refrigerant cycle is balanced, for example, when the refrigerant cycle is stopped. Insufficiency of a charge amount of the refrigerant can be grasped by detecting that the refrigerant pressure with respect to the refrigerant temperature detected is lower than a saturation pressure.

However, in an environment where the outside air temperature is extremely low, for example, −10° C. or lower, as illustrated in FIG. 8, the saturation pressure of the refrigerant becomes low, and a difference (AP) between the saturation pressure of the refrigerant and an atmospheric pressure prior to a start-up of the compressor becomes notably small. Consequently, a fluctuation range of the refrigerant pressure in accordance with insufficiency of the refrigerant also becomes relatively small when the outside air temperature becomes low. Therefore, considering a measurement error by a refrigerant pressure sensor for detecting the refrigerant pressure, a fluctuation of the refrigerant pressure in accordance with insufficiency of the refrigerant cannot be accurately grasped, and it becomes difficult to appropriately determine whether the refrigerant is insufficient.

In such a case, it may be considered to enhance a discharge refrigerant pressure by operating the compressor. However, when the outside air temperature is low (−10° C. or lower), heat is less likely to be absorbed from the outside air, and an increase in the refrigerant pressure cannot be expected. This makes it difficult to determine the charge state of the refrigerant.

Furthermore, detecting a refrigerant flow rate by positively operating the compressor may be also considered as a method for grasping the charge state of the refrigerant. However, when the refrigerant is insufficient, a lubricant that has flowed out of the compressor into the refrigerant cycle is not collected. This leads to a risk of degradation of the compressor at an early stage.

The invention has been achieved in consideration of such circumstances and has a main object to provide a vehicular heat cycle apparatus and a method of ascertaining a refrigerant charge state, which make it possible to appropriately grasp a charge state of a refrigerant (insufficiency of the refrigerant) in a refrigerant cycle even in an environment where an outside air temperature is low.

### Solution to Problem

In order to achieve the above object, a vehicular heat cycle apparatus (1) according to the invention includes:
a refrigerant cycle (20) inside which a refrigerant circulates and which includes: a compressor (21) configured to send out the refrigerant; a refrigerant and heat-medium heat exchanger (22) into which the refrigerant that has been sent out of the compressor (21) flows; an expansion valve (24) through which the refrigerant that has flowed out of the refrigerant and heat-medium heat exchanger (22) is passable; and a heat-absorption heat exchanger (25) into which the refrigerant that has passed through the expansion valve (24) flows;
a heat medium cycle (30) inside which a heat medium circulates and which includes: a pump (31) configured to send out the heat medium; a heat medium heating device (32) into which the heat medium that has been sent out of the pump (31) flows, the heat medium heating device (32) being capable of heating the heat medium; and a heat-dissipation heat exchanger (34) into which the heat medium that has flowed out of the heat medium heating device (32) flows, the heat-dissipation heat exchanger (34) being capable of dissipating heat from the heat medium, the heat medium cycle (30) being thermally coupled to the refrigerant cycle (20) with the refrigerant and heat-medium heat exchanger (22);
a refrigerant temperature detector (41) configured to detect a temperature of the refrigerant in the refrigerant cycle (20);
a refrigerant pressure detector (42) configured to detect a pressure of the refrigerant in the refrigerant cycle (20);
an outside air temperature detector (43) configured to detect a temperature of outside air; and
a controller (40) configured to control operations of the refrigerant cycle (20) and the heat medium cycle (30) and configured to determine a charge state of the refrigerant in the refrigerant cycle (20) using a refrigerant temperature (Tx) that has been detected by the refrigerant temperature detector (41), a refrigerant pressure (Px) that has been detected by the refrigerant pressure detector (42), and an outside air temperature (Toutx) that has been detected by the outside air temperature detector (43).

The heat-absorption heat exchanger (25) and the heat-dissipation heat exchanger (34) are disposed in an air blowing space (12) in an air conditioner (10) including a blower (11).

When it is determined that the outside air temperature (Toutx) is lower than a predetermined outside air temperature (Tout1), the controller (40) is configured to switch to a determination operation mode in which the expansion valve (24) is made fully open, and the compressor (21), the pump (31), and the heat medium heating device (32) are operated.

After switching to the determination operation mode, when the refrigerant temperature (Tx) exceeds a first predetermined refrigerant temperature (Tref1), the controller (40) is configured to make a determination whether a state of the refrigerant grasped from the refrigerant temperature (Tx) and the refrigerant pressure (Px) is in a refrigerant insufficiency region (L) set on a lower pressure side than a saturated vapor pressure curve (C) of the refrigerant by a predetermined pressure difference (S).

Therefore, when the outside air temperature (Toutx) is lower than the predetermined outside air temperature (Tout1), switching to the determination operation mode is performed in which heat of the heat medium heated by the heat medium heating device in the heat medium cycle is transmitted to the refrigerant in the refrigerant cycle via the refrigerant and heat-medium heat exchanger. Because the refrigerant is heated, a difference between a saturation pressure of the refrigerant and an atmospheric pressure can be increased. Consequently, in the case that the refrigerant temperature (Tx) exceeds the first predetermined refrigerant temperature (Tref1), when a state of the refrigerant grasped from the refrigerant temperature (Tx) and the refrigerant pressure (Px) that have been detected is compared with the saturated vapor pressure curve (C), which is an inherent value in each component of the refrigerant, it becomes easier to grasp whether the state of the refrigerant grasped from the refrigerant temperature (Tx) and the refrigerant pressure (Px) that have been detected is lower than a pressure obtained by subtracting the predetermined pressure difference(S) from the saturated vapor pressure curve (C) of the refrigerant. Thus, accuracy in determining insufficiency of the refrigerant can be enhanced.

Here, the controller (40) may be configured to stop the blower (11) until the determination by the refrigerant insufficiency determination unit is completely made.

Such control is performed to prevent heat dissipation from the heat-dissipation heat exchanger and the heat-absorption heat exchanger by air blown by the blower in the determination operation mode, thereby promoting heating of the heat medium and promoting heat accumulation in the refrigerant. That is, because heat generated in the heat medium cycle and heat accumulated in the refrigerant cycle is prevented from being dissipated by blown air from the blower, the heat transmitted from the heat medium to the refrigerant can be effectively accumulated in the refrigerant so as to increase the refrigerant temperature at an early stage, thereby quickly determining whether the refrigerant is insufficient.

Alternatively, in order to achieve the above object, a vehicular heat cycle apparatus (1A) may include:
a refrigerant cycle (20) inside which a refrigerant circulates and which includes: a compressor (21) configured to send out the refrigerant; a refrigerant and heat-medium heat exchanger (22) into which the refrigerant that has been sent out of the compressor (21) flows; an expansion valve (24) through which the refrigerant that has flowed out of the refrigerant and heat-medium heat exchanger (22) is passable; a heat-absorption heat exchanger (25) into which the refrigerant that has passed through the expansion valve (24) flows; a bypass passage (26) coupling a passage between an outlet portion of the refrigerant and heat-medium heat exchanger (22) and an inlet portion of the expansion valve (24) to a passage between an outlet portion of the heat-absorption heat exchanger (25) and an intake portion of the compressor (21); a bypass-side expansion valve (27) through which the refrigerant that has flowed out of the refrigerant and heat-medium heat exchanger (22) is passable, the bypass-side expansion valve (27) being disposed on the bypass passage (26); and a bypass-side heat-absorption heat exchanger (29) into which the refrigerant that has passed through the bypass-side expansion valve (27) flows, so that the refrigerant is configured to collect heat of a heating element (28), the bypass-side heat-absorption heat exchanger (29) being disposed on the bypass passage (26);
a heat medium cycle (30) inside which a heat medium circulates and which includes: a pump (31) configured to send out the heat medium; a heat medium heating device (32) into which the heat medium that has been sent out of the pump (31) flows, the heat medium heating device (32) being capable of heating the heat medium; and a heat-dissipation heat exchanger (34) into which the heat medium that has flowed out of the heat medium heating device (32) flows, the heat-dissipation heat exchanger (34) being capable of dissipating heat from the heat medium, the heat medium cycle (30) being thermally coupled to the refrigerant cycle (20) at the refrigerant and heat-medium heat exchanger (22);
a refrigerant temperature detector (41) configured to detect a temperature of the refrigerant in the refrigerant cycle (20);
a refrigerant pressure detector (42) configured to detect a pressure of the refrigerant in the refrigerant cycle (20);
an outside air temperature detector (43) configured to detect a temperature of outside air; and
a controller (40) configured to control operations of the refrigerant cycle (20) and the heat medium cycle (30) and configured to determine a charge state of the refrigerant in the refrigerant cycle (20) using a refrigerant temperature (Tx) that has been detected by the refrigerant temperature detector (41), a refrigerant pressure (Px) that has been detected by the refrigerant pressure detector (42), and an outside air temperature (Toutx) that has been detected by the outside air temperature detector (43).

The heat-absorption heat exchanger (25) and the heat-dissipation heat exchanger (34) may be disposed in an air blowing space (12) in an air conditioner (10) including a blower (11).

When it is determined that the outside air temperature (Toutx) is lower than a predetermined outside air temperature (Tout1), the controller (40) may be configured to switch to a determination operation mode in which the expansion valve (24) is made closed, the bypass-side expansion valve (27) is made fully open, and the compressor (21), the pump (31), and the heat medium heating device (32) are operated.

After switching to the determination operation mode, when the refrigerant temperature (Tx) exceeds a first predetermined refrigerant temperature (Tref1), the controller (40) may be configured to make a determination whether a state of the refrigerant grasped from the refrigerant temperature (Tx) and the refrigerant pressure (Px) is in a refrigerant insufficiency region (L) set on a lower pressure side than a saturated vapor pressure curve (C) of the refrigerant by a predetermined pressure difference (S).

In such a configuration, when the outside air temperature (Toutx) is lower than the predetermined outside air temperature (Tout1), switching to the determination operation mode is performed to increase a difference between a saturation pressure of the refrigerant and an atmospheric pressure, so that it becomes easier to grasp whether the state of the refrigerant grasped from the refrigerant temperature (Tx) and the refrigerant pressure (Px) that have been detected is lower than a pressure obtained by subtracting the predetermined pressure difference (S) from the saturated vapor pressure curve (C) of the refrigerant, which leads to an effect of enhancing accuracy in determining insufficiency of the refrigerant.

In addition, the bypass passage bypassing the heat-absorption heat exchanger is disposed in the refrigerant cycle, and the bypass-side heat-absorption heat exchanger capable of collecting heat from the heating element is disposed on the bypass passage, so that when the refrigerant temperature is enhanced, not only the heat transmitted from the heat medium via the refrigerant and heat-medium heat exchanger but also the heat collected from the heating element can be used to rapidly increase the refrigerant temperature, thereby making it possible to quickly determine whether the refrigerant is insufficient.

Here, after switching to the determination operation mode, the controller (40) may be configured to operate the blower (11) so as to secure blown air to the heat-dissipation heat exchanger (34) by the blower (11).

In such a configuration, in the determination operation mode, heat generated from the heating element can be used to enhance the refrigerant temperature, and also, heat generated by the heat medium heating device can be used to heat a vehicle cabin (CR), so that heating of an interior of the vehicle cabin (CR) can be performed in parallel to determination of a charge amount of the refrigerant in the refrigerant cycle.

In the vehicular heat cycle apparatus (1, 1A), the refrigerant temperature detector (41) and the refrigerant pressure detector (42) may be disposed on one or both of a discharge side and an intake side of the compressor (21).

Although the refrigerant temperature detector and the refrigerant pressure detector may be positioned at least on the high pressure side (discharge side) from a viewpoint of protecting the compressor, the refrigerant temperature detector and the refrigerant pressure detector may be positioned on the intake side so as to grasp an average pressure of the entire refrigerant route and to grasp an amount of the refrigerant on the low pressure side.

Further, in the vehicular heat cycle apparatus (1, 1A), the determination is desirably made when the refrigerant cycle (20) is operated after the heat medium cycle (30) has been operated.

In such a configuration, because the heat medium cycle is first operated, the heat medium temperature can be first increased, and thereafter, by operating the refrigerant cycle, operation time of the refrigerant cycle until a determination result is obtained can be shortened. In case of insufficiency of the refrigerant, long-term operation of the compressor can be avoided.

The above-described configurations can be regarded as a method of ascertaining a refrigerant charge state using the vehicular heat cycle apparatus and can be also specified as a method of determining whether the refrigerant is insufficient after an operation mode is switched to the determination operation mode.

That is, a method of ascertaining a refrigerant charge state using a vehicular heat cycle apparatus (1) including:
a refrigerant cycle (20) inside which a refrigerant circulates and which includes: a compressor (21) configured to send out the refrigerant; a refrigerant and heat-medium heat exchanger (22) into which the refrigerant that has been sent out of the compressor (21) flows; an expansion valve (24) through which the refrigerant that has flowed out of the refrigerant and heat-medium heat exchanger (22) is passable; and a heat-absorption heat exchanger (25) into which the refrigerant that has passed through the expansion valve (24) flows;
a heat medium cycle (30) inside which a heat medium circulates and which includes: a pump (31) configured to send out the heat medium; a heat medium heating device (32) into which the heat medium that has been sent out of the pump (31) flows, the heat medium heating device (32) being capable of heating the heat medium; and a heat-dissipation heat exchanger (34) into which the heat medium that has flowed out of the heat medium heating device (32) flows, the heat-dissipation heat exchanger (34) being capable of dissipating heat from the heat medium, the heat medium cycle (30) being thermally coupled to the refrigerant cycle (20) at the refrigerant and heat-medium heat exchanger (22);
a refrigerant temperature detector (41) configured to detect a temperature of the refrigerant in the refrigerant cycle (20);
a refrigerant pressure detector (42) configured to detect a pressure of the refrigerant in the refrigerant cycle (20);
an outside air temperature detector (43) configured to detect a temperature of outside air; and
a controller (40) configured to control operations of the refrigerant cycle (20) and the heat medium cycle (30) and configured to determine a charge state of the refrigerant in the refrigerant cycle (20) using a refrigerant temperature (Tx) that has been detected by the refrigerant temperature detector (41), a refrigerant pressure (Px) that has been detected by the refrigerant pressure detector (42), and an outside air temperature (Toutx) that has been detected by the outside air temperature detector (43),
the heat-absorption heat exchanger (25) and the heat-dissipation heat exchanger (34) being disposed in an air blowing space (12) in an air conditioner (10) including a blower (11),
the method may include:

operation mode switching steps (S05 to S07) of, when it is determined that the outside air temperature (Toutx) is lower than a predetermined outside air temperature (Tout1), switching to a determination operation mode in which the expansion valve (24) is made fully open, and the compressor (21), the pump (31), and the heat medium heating device (32) are operated, and
refrigerant charge state determination steps (S09 and S10) of, after switching to the determination operation mode, when the refrigerant temperature (Tx) exceeds a first predetermined refrigerant temperature (Tref1), determining a divergence degree of an actual pressure of the refrigerant with respect to a saturation pressure of the refrigerant at the temperature, so as to make a determination from the divergence degree as to whether the refrigerant in the refrigerant cycle (20) is insufficient.

Alternatively, a method of ascertaining a refrigerant charge state using a vehicular heat cycle apparatus (1A) including:
a refrigerant cycle (20) inside which a refrigerant circulates and which includes: a compressor (21) configured to send out the refrigerant; a refrigerant and heat-medium heat exchanger (22) into which the refrigerant that has been sent out of the compressor (21) flows; an expansion valve (24) through which the refrigerant that has flowed out of the refrigerant and heat-medium heat exchanger (22) is passable; a heat-absorption heat exchanger (25) into which the refrigerant that has passed through the expansion valve (24) flows; a bypass passage (26) coupling a passage between an outlet portion of the refrigerant and heat-medium heat exchanger (22) and an inlet portion of the expansion valve (24) to a passage between an outlet portion of the heat absorption heat exchanger (25) and an intake portion of the compressor (21); a bypass side expansion valve (27) through which the refrigerant that has flowed out of the refrigerant and heat-medium heat exchanger (22) is passable, the bypass-side expansion valve (27) being disposed on the bypass passage (26); and a bypass-side heat-absorption heat exchanger (29) into which the refrigerant that has passed through the bypass-side expansion valve (27) flows, so that the refrigerant is configured to collect heat of a heating element (28), the bypass-side heat-absorption heat exchanger (29) being disposed on the bypass passage (26);
a heat medium cycle (30) inside which a heat medium circulates and which includes: a pump (31) configured to send out the heat medium; a heat medium heating device (32) into which the heat medium that has been sent out of the pump (31) flows, the heat medium heating device (32) being capable of heating the heat medium; and a heat-dissipation heat exchanger (34) into which the heat medium that has flowed out of the heat medium heating device (32) flows, the heat-dissipation heat exchanger (34) being capable of dissipating heat from the heat medium, the heat medium cycle (30) being thermally coupled to the refrigerant cycle (20) at the refrigerant and heat-medium heat exchanger (22);
a refrigerant temperature detector (41) configured to detect a temperature of the refrigerant in the refrigerant cycle (20);
a refrigerant pressure detector (42) configured to detect a pressure of the refrigerant in the refrigerant cycle (20);
an outside air temperature detector (43) configured to detect a temperature of outside air; and
a controller (40) configured to control operations of the refrigerant cycle (20) and the heat medium cycle (30) and configured to determine a charge state of the refrigerant in the refrigerant cycle (20) using a refrigerant temperature (Tx) that has been detected by the refrigerant temperature detector (41), a refrigerant pressure (Px) that has been detected by the refrigerant pressure detector (42), and an outside air temperature (Toutx) that has been detected by the outside air temperature detector (43),
the heat-absorption heat exchanger (25) and the heat-dissipation heat exchanger (34) being disposed in an air blowing space (12) of an air conditioner (10) including a blower (11),
the method may include:
operation mode switching steps (S15 to S17) of, when it is determined that the outside air temperature (Toutx) is lower than a predetermined outside air temperature (Tout1), switching to a determination operation mode in which the expansion valve (24) is made closed, the bypass-side expansion valve (27) is made fully open, and the compressor (21), the pump (31), and the heat medium heating device (32) are operated, and
refrigerant charge state determination steps (S09 and S10) of, after switching to the determination operation mode, when the refrigerant temperature (Tx) exceeds a first predetermined refrigerant temperature (Tref1), determining a divergence degree of an actual pressure of the refrigerant with respect to a saturation pressure of the refrigerant at the temperature, so as to make a determination from the divergence degree as to whether the refrigerant in the refrigerant cycle (20) is insufficient.

The method of ascertaining a refrigerant charge state using the vehicular heat cycle apparatus (1, 1A) may further include a compressor protection step (S 12) of switching to a compressor protection mode of protecting the compressor (21) by stopping the compressor (21) when it is determined from the refrigerant charge state determination steps (S09 and S10) that the refrigerant cycle (20) has refrigerant insufficiency.

In the case that a charge amount of the refrigerant is determined to be insufficient, when the compressor is kept operated, a risk of degrading the compressor at an early stage is increased. Therefore, stopping the compressor makes it possible to protect the compressor.

### Advantageous Effects of Invention

As described above, with the vehicular heat cycle apparatus (1, 1A) according to the invention and the method using the same, when it is determined that the outside air temperature (Toutx) is lower than the predetermined outside air temperature (Tout1), switching to the determination operation mode is performed in which heat of the heat medium heated in the heat medium cycle is transferred to the refrigerant in the refrigerant cycle via the refrigerant and heat-medium heat exchanger, so that after the refrigerant temperature is enhanced, it is determined whether the refrigerant is insufficient. That is, when the refrigerant temperature (Tx) exceeds the first predetermined refrigerant temperature (Tref1), it is determined whether a state of the refrigerant grasped from the refrigerant temperature (Tx) and the refrigerant pressure (Px) is in the refrigerant insufficiency region (L) set on a lower pressure side than the saturated vapor pressure curve (C) of the refrigerant by the predetermined pressure difference(S). Therefore, even in an environment where an outside air temperature is extremely low, a charge state of the refrigerant (insufficiency of the refrigerant) in the refrigerant cycle can be appropriately grasped.

### BRIEF DESCRIPTION OF DRAWINGS

FIG. 1 is a diagram illustrating a vehicular heat cycle apparatus according to a first embodiment of the invention.

FIG. 2 is diagrams each illustrating an operation mode of the vehicular heat cycle apparatus illustrated in FIG. 1. FIG. 2(a) illustrates a state of a determination operation mode. FIG. 2(b) illustrates a state of a heating operation mode. FIG. 2(c) illustrates a state of a dehumidification operation mode. FIG. 2(d) illustrates a state of a cooling operation mode.

FIG. 3 is a flowchart illustrating a method of determining insufficiency of a refrigerant by a controller in the case of using the vehicular heat cycle apparatus illustrated in FIG. 1.

FIG. 4 is a graph illustrating the method of determining insufficiency of the refrigerant in a refrigerant cycle.

FIG. 5 is a diagram illustrating a vehicular heat cycle apparatus according to a second embodiment of the invention.

FIG. 6 is diagrams each illustrating an operation mode of the vehicular heat cycle apparatus illustrated in FIG. 5. FIG. 6(a) illustrates a state of a determination operation mode. FIG. 6(b) illustrates a state of a heating operation mode. FIG. 6(c) illustrates a state of a dehumidification operation mode. FIG. 6(d) illustrates a state of a cooling operation mode.

FIG. 7 is a flowchart illustrating a method of determining insufficiency of a refrigerant by a controller in the case of using the vehicular heat cycle apparatus illustrated in FIG. 5.

FIG. 8 is a graph illustrating a saturated vapor pressure curve of the refrigerant.

### DESCRIPTION OF EMBODIMENTS

### First Embodiment

Hereinafter, embodiments of a vehicular heat cycle apparatus according to the invention will be described with reference to the drawings.

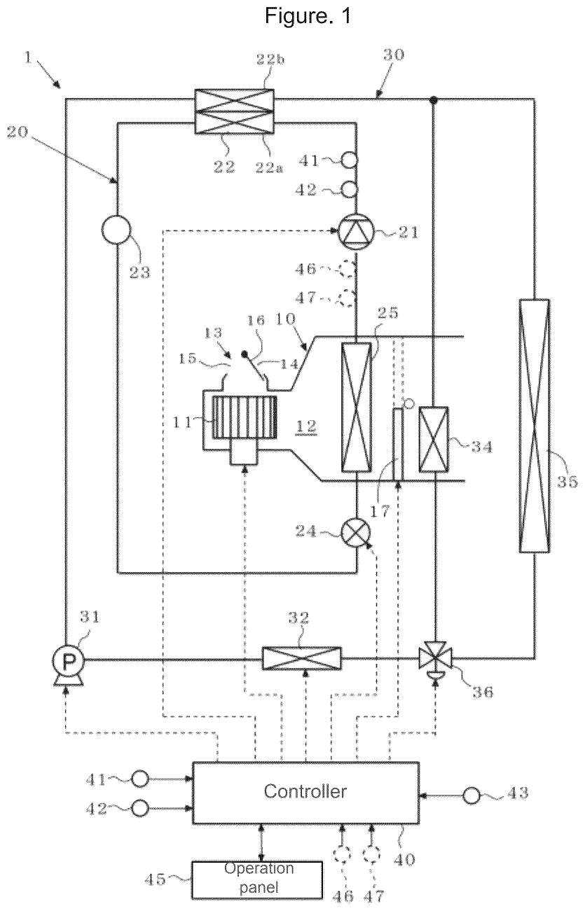

FIG. 1 illustrates a first embodiment of the vehicular heat cycle apparatus (a vehicular heat cycle apparatus 1). The vehicular heat cycle apparatus 1 is mounted in a vehicle V and operates in accordance with various operation modes using a refrigerant cycle 20 and a heat medium cycle 30 thermally coupled to the refrigerant cycle 20. In particular, the vehicular heat cycle apparatus 1 is capable of determining a charge state of a refrigerant in the refrigerant cycle 20.

The refrigerant circulates inside the refrigerant cycle 20, which includes the following coupled in sequence with piping: a compressor 21 for sending out the refrigerant; a refrigerant and heat-medium heat exchanger 22 into which the refrigerant that has been sent out of the compressor 21 flows; a liquid tank 23 for performing gas-liquid separation of the refrigerant that has flowed out of the refrigerant and heat-medium heat exchanger 22; an expansion valve 24 through which the refrigerant that has flowed out of the liquid tank 23 is passable; and a heat-absorption heat exchanger 25 into which the refrigerant that has passed through the expansion valve 24 flows.

The refrigerant is not limited to a particular kind as long as the refrigerant has a composition for implementing functions. For example, a fluorocarbon medium (HFC-134a, R-1234yf) or carbon dioxide (CO2) is used.

The compressor 21 contains a compression mechanism of the refrigerant inside and have functions of sucking the refrigerant, compressing the refrigerant into a high-temperature and high-pressure state, and discharging the refrigerant by rotating the compression mechanism. The compressor 21 used in the invention is not limited to a particular kind as long as the compressor implements the functions. For example, an electric compressor driven by an electric motor is used.

The liquid tank 23 is not limited to a particular kind as long as the liquid tank implements functions. It is noted that instead of the liquid tank 23, an accumulator, not illustrated, may be provided between the heat-absorption heat exchanger 25 and the compressor 21.

As the expansion valve 24, not a mechanical expansion valve but an electronic expansion valve is used. An opening degree of the electronic expansion valve can be adjusted as suited by a control signal from an outside, so that the refrigerant can pass through the electronic expansion valve without being depressurized and expanded by setting the opening degree as fully open.

The heat medium circulates inside the heat medium cycle 30, which includes:
a pump 31 for sending out the heat medium; a heat medium heating device 32 into which the heat medium that has been sent out of the pump 31 flows, so that the heat medium heating device 32 can heat the heat medium; a heat-dissipation heat exchanger 34 into which the heat medium that has flowed out of the heat medium heating device 32 flows, so that the heat-dissipation heat exchanger 34 can dissipate heat from the heat medium; and the refrigerant and heat-medium heat exchanger 22 into which the heat medium that has flowed out of the heat-dissipation heat exchanger 34 flows, the refrigerant and heat-medium heat exchanger 22 being thermally coupled to the refrigerant cycle 20.

The heat medium is not limited to a particular kind as long as the heat medium has a composition for implementing functions. For example, water, an antifreeze, or a coolant containing an antirust component is used.

The heat medium heating device 32 includes a heating flow path where the heat medium flows, and an electric heating element (such as spiral electric heating wire), which is disposed inside the heating flow path and heats the heat medium flowing in the heating flow path.

The refrigerant and heat-medium heat exchanger 22 includes a refrigerant passage portion 22a where the refrigerant of the refrigerant cycle 20 flows, and a heat medium passage portion 22b where the heat medium of the heat medium cycle 30 flows. The refrigerant and heat-medium heat exchanger 22 transmits heat between the refrigerant flowing in the refrigerant passage portion 22a and the heat medium flowing in the heat medium passage portion 22b, and is occasionally referred to as a water condenser.

Moreover, the heat medium cycle 30 is coupled in parallel to the heat-dissipation heat exchanger 34, and further includes a vehicle-cabin external heat exchanger (radiator) 35 for exchanging heat with air outside the vehicle cabin CR. A three-way valve 36 is interposed between the heat medium heating device 32 and the heat-dissipation heat exchanger 34 in such a manner that the heat medium that has flowed out of the heat medium heating device 32 is switchable whether the heat medium is sent out to the heat-dissipation heat exchanger 34 or to the vehicle-cabin external heat exchanger 35 by the three-way valve 36.

The heat-absorption heat exchanger 25 of the refrigerant cycle 20 and the heat-dissipation heat exchanger 34 of the heat medium cycle 30 are disposed in an air blowing space 12 in the air conditioner 10 including a blower 11. Specifically, the air conditioner 10 is disposed in the vehicle cabin CR behind a partition, not illustrated, which divides the vehicle V into a vehicle front compartment FR and the vehicle cabin CR. An inside/outside air switching device 13 is disposed most upstream of the air conditioner 10. A ratio of opening degrees of an inside air inlet 14 and an outside air inlet 15 is adjustable by an intake door 16. Inside and/or outside air introduced into the air conditioner 10 is sucked by rotation of the blower 11 and sent to the heat-absorption heat exchanger 25 and the heat-dissipation heat exchanger 34 disposed in the air blowing space 12. After heat exchange of the air is suitably performed to adjust the air at a desired temperature in the heat-absorption heat exchanger 25 and the heat-dissipation heat exchanger 34, the air is supplied to the vehicle cabin CR via plural outlets, not illustrated, disposed in the air conditioner 10.

The heat-absorption heat exchanger 25 is disposed to block a whole cross section of the air blowing space 12 in the air conditioner 10 in such a manner that all of the air that has been introduced into the air conditioner 10 by rotation of the blower 11 passes through the heat-absorption heat exchanger 25. The heat-dissipation heat exchanger 34 is disposed downstream of the heat-absorption heat exchanger 25 so as to partly block the cross section of the air blowing space 12 and to form a passage for bypassing the heat-dissipation heat exchanger 34. The air mix door 17 for adjusting a flow ratio of the air passing through the heat-dissipation heat exchanger 34 and the air bypassing the heat-dissipation heat exchanger 34 is interposed between the heat-absorption heat exchanger 25 and the heat-dissipation heat exchanger 34.

Here, the air mix door 17 may be a slide door as illustrated in the drawings or may be a cantilevered or butterfly revolving door, not illustrated.

A refrigerant temperature sensor (refrigerant temperature detector) 41 for detecting a temperature of the refrigerant in the refrigerant cycle 20, and a refrigerant pressure sensor (refrigerant pressure detector) 42 for detecting a pressure of the refrigerant in the refrigerant cycle 20 are disposed at a discharge side of the compressor 21 of the refrigerant cycle 20. Moreover, an outside air temperature sensor (outside air temperature detector) 43 for detecting a temperature of outside air of the vehicle V is disposed at an appropriate position of the vehicle V. Detection data detected by these sensors (detectors) and control signals from an operation panel 45 are input to the controller 40 and used for controlling a drive state of the compressor 21, an opening degree of the expansion valve 24, an amount of blown air by the blower 11, switching of the three-way valve 36, a position of the air mix door 17, switching and a rotational speed of the compressor 21, switching of the pump 31, and switching of the heat medium heating device 32, for example.

Next, a description will be given on normal operation modes (a heating operation mode, a dehumidification operation mode, and a cooling operation mode) for air conditioning of the interior of the vehicle cabin CR using the vehicular heat cycle apparatus 1 with the above configuration.

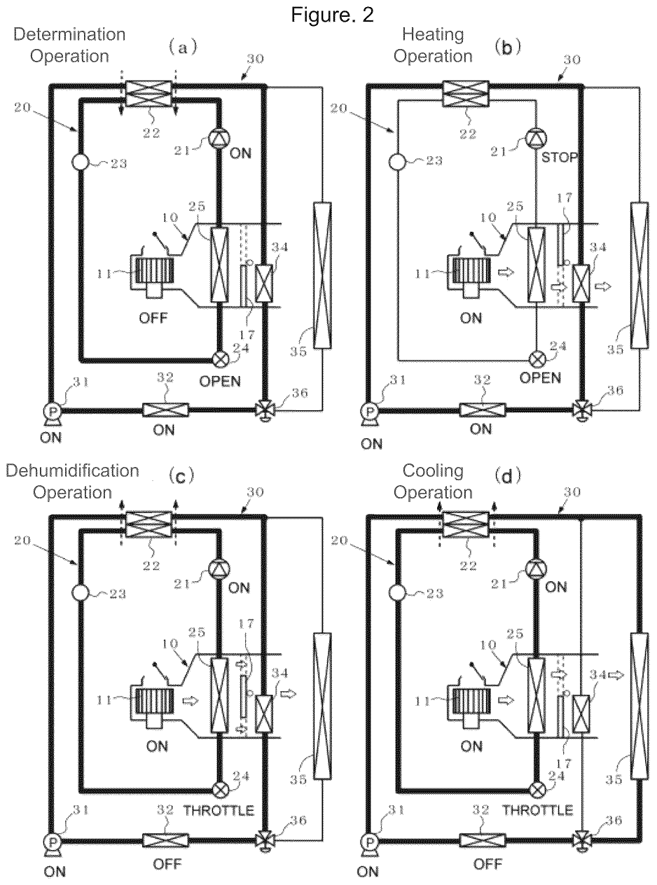

Refer to FIG. 2(b). When an operation mode is set as the heating operation mode (the heating operation mode in the first embodiment), the controller 40 stops the compressor 21 and does not operate the refrigerant cycle 20. The pump 31 is turned on, and the heat medium cycle 30 is operated. At this time, the heat medium is heated by turning on the heat medium heating device 32, and the three-way valve 36 is set in such a state as to allow the heat medium heating device 32 and the heat-dissipation heat exchanger 34 to communicate with each other. Further, the air mix door 17 is set at a full hot position, and the blower 11 is rotated (turned on).

Then, in the heat medium cycle 30, the heat medium that has been sent out of the pump 31 is heated by the heat medium heating device 32, and thereafter heats air that has been introduced into the air conditioner 10 (air blown from the blower 11) in the heat-dissipation heat exchanger 34. At this time, because the refrigerant cycle 20 is not operated, the air blown from the blower 11 is not cooled when passing through the heat-absorption heat exchanger 25 but guided to the heat-dissipation heat exchanger 34, and after the air is heated by the heat-dissipation heat exchanger 34, the air is supplied to the vehicle cabin CR. In this case, because the refrigerant cycle 20 is not operated, the refrigerant does not positively absorb heat from the heat medium in the refrigerant and heat-medium heat exchanger 22. Therefore, the heat medium from which the heat has been absorbed in the heat-dissipation heat exchanger 34 flows into the heat medium heating device 32 without excessively decreasing in temperature, and the heat medium after heated re-enters the heat-dissipation heat exchanger 34, so that the vehicle cabin CR can be quickly enhanced in temperature.

Refer to FIG. 2(c). When the operation mode is set as the dehumidification operation mode, the controller 40 turns on the compressor 21 and operates the refrigerant cycle 20. At this time, the expansion valve 24 is set in a throttle state to obtain a dehumidification function. The pump 31 is turned on, and the heat medium cycle 30 is operated. At this time, the heat medium heating device 32 is turned off so as not to heat the heat medium, and the three-way valve 36 is set in such a state as to allow the heat medium heating device 32 and the heat-dissipation heat exchanger 34 to communicate with each other. Further, the air mix door 17 is set at an intermediate position, and the blower 11 is rotated.

Then, in the refrigerant cycle 20, the high-temperature and high-pressure refrigerant that has been discharged from the compressor 21 dissipates heat to the heat medium in the refrigerant and heat-medium heat exchanger 22 and flows into the expansion valve 24 via the liquid tank 23. After being depressurized and expanded, the refrigerant flows into the heat-absorption heat exchanger 25 and absorbs heat from the air that has been introduced into the air conditioner 10 (air blown from the blower 11). That is, the air that has been introduced into the air conditioner 10 is dehumidified.

In the heat medium cycle 30, the heat medium that has been sent out of the pump 31 flows into the heat-dissipation heat exchanger 34 without being heated by the heat medium heating device 32. At this time, because the heat medium has absorbed heat from the refrigerant (been heated by the refrigerant) in the refrigerant and heat-medium heat exchanger 22, the heat medium flowing into the heat-dissipation heat exchanger 34 has a constant amount of heat. Therefore, the air that has been dehumidified by passing through the heat-absorption heat exchanger 25 is partly guided to the heat-dissipation heat exchanger 34 in accordance with an opening degree of the air mix door 17 and heated whereas the rest of the air bypasses the heat-dissipation heat exchanger 34 and is mixed and sent out to the vehicle cabin CR. For example, when the air mix door 17 is made closer to a full cool position, dehumidification cooling can be performed, and when the air mix door 17 is made closer to the full hot position, dehumidification heating can be performed.

It is noted that although the heat medium is not heated by turning off the heat medium heating device 32 in the above description, the heat medium may be heated by turning on the heat medium heating device 32. The dehumidification heating operation can be performed.

In the above description, the three-way valve 36 is set in such a state as to allow the heat medium heating device 32 and the heat-dissipation heat exchanger 34 to communicate with each other. Alternatively, however, the three-way valve 36 may be set in such a manner that the heat medium that has flowed from the heat medium heating device 32 into the three-way valve 36 flows to the vehicle-cabin external heat exchanger 35 in addition to the heat-dissipation heat exchanger 34. Even when the air that has passed through the heat-absorption heat exchanger 25 is heated (reheated) by the heat-dissipation heat exchanger 34, the dehumidification cooling operation can be performed by reducing an amount of the heat medium flowing in the heat-dissipation heat exchanger 34.

Refer to FIG. 2(d). When the operation mode is set as the cooling operation mode, the controller 40 turns on the compressor 21 and operates the refrigerant cycle 20. At this time, the expansion valve 24 is set in a throttle state in accordance with a heat load of the blown air flowing into the heat-absorption heat exchanger 25 (the air flowing in the air blowing space 12 in the air conditioner 10) so as to sufficiently cool the vehicle cabin CR. The pump 31 is turned on, and the heat medium cycle 30 is operated. At this time, the heat medium heating device 32 is turned off so as not to heat the heat medium, and the three-way valve 36 is set in such a state as to allow the heat medium heating device 32 and the vehicle-cabin external heat exchanger 35 to communicate with each other. Further, the air mix door 17 is set at the full cool position, and the blower 11 is rotated.

Then, in the refrigerant cycle 20, the high-temperature and high-pressure refrigerant that has been discharged from the compressor 21 dissipates heat to the heat medium in the refrigerant and heat-medium heat exchanger 22 and flows into the expansion valve 24 via the liquid tank 23. After being depressurized and expanded, the refrigerant flows into the heat-absorption heat exchanger 25 and absorbs heat from the air that has been introduced into the air conditioner 10 (air blown from the blower 11). That is, the air that has been introduced into the air conditioner 10 is cooled. Since the air mix door 17 is set at the full cool position, the air that has passed through the heat-absorption heat exchanger 25 is not heated but supplied as it is to the vehicle cabin CR.

Meanwhile, in the heat medium cycle 30, the heat medium that has been sent out of the pump 31 is not heated by the heat medium heating device 32 but circulates via the vehicle-cabin external heat exchanger 35 and the refrigerant and heat-medium heat exchanger 22. After having absorbed heat from the refrigerant in the refrigerant and heat-medium heat exchanger 22, the heat medium dissipates the heat to outside air of the vehicle V in the vehicle-cabin external heat exchanger 35. That is, the heat that has absorbed from the blown air by the heat-absorption heat exchanger 25 is dissipated to the outside of the vehicle V via the refrigerant and heat-medium heat exchanger 22 and the vehicle-cabin external heat exchanger 35, so that the air that has been introduced into the air conditioner 10 (the air blown from the blower 11) can be efficiently cooled.

Incidentally, the case of setting the heating operation mode generally refers to the case in which outside air of the vehicle V has a low temperature. Therefore, in view of temperature adjustment in the vehicle cabin CR, there is little need to cool the blown air by operating the refrigerant cycle 20. Meanwhile, when the outside air temperature is low, window glass is likely to get dew-condensed. In view of securing visibility, there is rather a demand for dehumidifying the blown air by operating the refrigerant cycle 20. That is, there is need to perform the dehumidification operation or the dehumidification heating operation.

Then, as long as the refrigerant cycle 20 is operated by turning on the compressor 21, there is need to secure a sufficient charge amount of the refrigerant in the refrigerant cycle 20 irrespective of a condition of the outside air temperature. When the charge amount of the refrigerant is insufficient, the compressor 21 is excessively operated (for example, operated at a higher rotational speed than intended or operated for longer time than intended) without obtaining an intended dehumidification capacity. This may unfortunately cause inconvenience of early degradation of the compressor 21. In another case, a lubricant, which is supposed to circulate inside the refrigerant cycle 20 along with the circulating refrigerant, stagnates inside the refrigerant cycle 20 without being sufficiently collected by the compressor 21. This may unfortunately cause inconvenience of early degradation of the compressor 21. Therefore, it is necessary to appropriately determine whether the charge amount of the refrigerant in the refrigerant cycle 20 is insufficient also when the outside air temperature is low (at the time of an extremely low temperature of −10° C. or less).

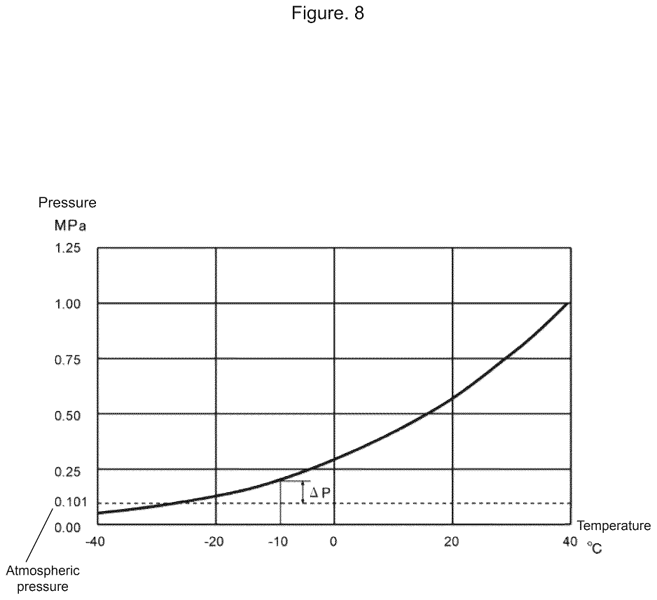

Here, as illustrated in FIG. 8, the refrigerant has a physical property that a difference (AP) between a saturation pressure and an atmospheric pressure at the time of a low temperature is small. A significant difference between a state in which the charge amount of the refrigerant in the refrigerant cycle 20 is sufficient and a state in which the charge amount of the refrigerant is insufficient is extremely small. Further, considering a detection error by a refrigerant pressure sensor in general use, it is difficult to accurately determine a refrigerant charge state (insufficiency of the refrigerant) at the time of a low temperature. Therefore, it is desirable to evaluate whether the refrigerant is insufficient after enhancing the refrigerant temperature to such a degree that the difference between the saturation pressure and the atmospheric pressure is sufficiently large. However, it causes another problem how to enhance the refrigerant temperature in the refrigerant cycle 20 at the time of an extremely low temperature.

In view of this, the refrigerant cycle 20 and the heat medium cycle 30 described above are used to form a determination operation mode, described below, so as to make it possible to determine the refrigerant charge state (whether the refrigerant is insufficient) in the refrigerant cycle 20 before the refrigerant cycle 20 is used as a dehumidification device.

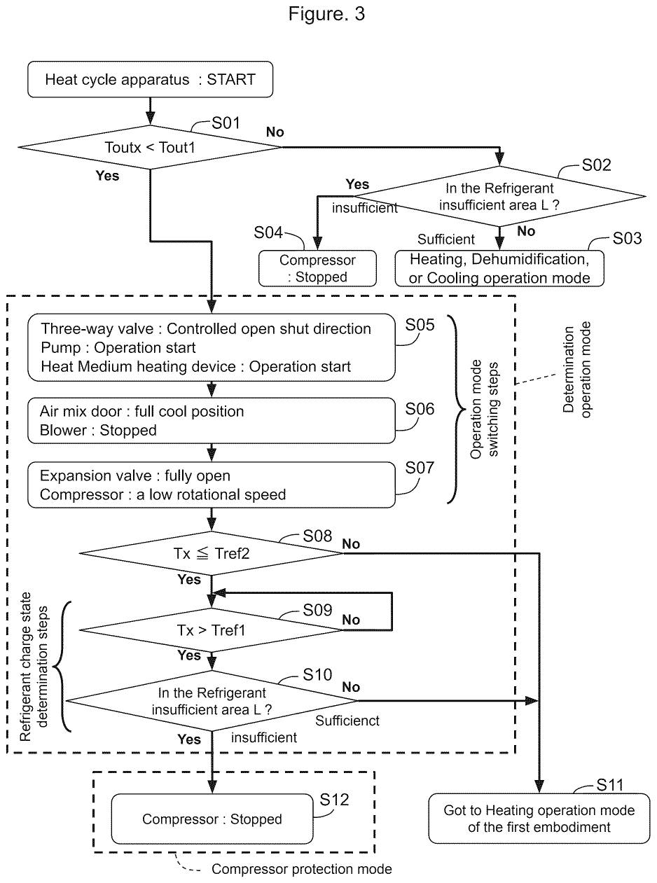

The determination operation mode is temporarily set to determine the refrigerant charge state when outside air has a low temperature. Hereinafter, an operation processing example of the determination operation mode including switching control of the operation modes by the controller 40 will be described based on a flowchart illustrated in FIG. 3.

First, when the vehicular heat cycle apparatus 1 is starting up, the controller 40 determines whether an outside air temperature Toutx that has been detected by the outside air temperature sensor 43 is lower than a predetermined outside air temperature Tout1 (step S01). The predetermined outside air temperature Tout1 is set as a limit temperature at which the difference between the saturation pressure of the refrigerant and the atmospheric pressure makes it possible to appropriately grasp a fluctuation in the refrigerant caused by insufficiency of the refrigerant. For example, the predetermined outside air temperature Tout1 is set at 5° C.

When it is determined that the outside air temperature Toutx is the predetermined outside air temperature Tout1 or higher, the difference between the saturation pressure of the refrigerant and the atmospheric pressure is a pressure difference that makes it possible to appropriately grasp a pressure fluctuation caused by insufficiency of the refrigerant (i.e., a pressure difference that makes it possible to reliably measure a pressure fluctuation in case of insufficiency of the refrigerant even when a measurement error by the refrigerant pressure sensor 42 is anticipated). Consequently, there is no need to enhance the refrigerant pressure by further heating the refrigerant than in a present state. By determining whether a state of the refrigerant grasped from a refrigerant temperature Tx that has been detected by the refrigerant temperature sensor 41 and a refrigerant pressure Px that has been detected by the refrigerant pressure sensor 42 is diverged from a saturated vapor pressure curve C by a predetermined pressure difference S or more (i.e., whether a refrigerant state grasped is in a refrigerant insufficiency region L, described later), it is determined whether the refrigerant is insufficient (step S02).

As a result, when there is almost no divergence from the saturated vapor pressure curve C and when insufficiency of the refrigerant is not recognized, shifting to one of the heating operation mode, the dehumidification operation mode, and the cooling operation mode in the first embodiment is performed in accordance with a heat load inside the vehicle cabin CR (step S03). In contrast, when it is determined that divergence from the saturated vapor pressure curve C is the predetermined pressure difference S or larger, the charge amount of the refrigerant in the refrigerant cycle 20 is insufficient. Consequently, when the operation is continued in one of the operation modes as it is, there is a possibility of early degradation of the compressor 21, so that the compressor 21 is stopped (step S04).

Incidentally, at step S01, when it is determined that the outside air temperature Toutx that has been detected by the outside air temperature sensor 43 is lower than the predetermined outside air temperature Tout1 (when it is determined that the outside air temperature Toutx is less than 5° C.), the difference between the saturation pressure of the refrigerant and the atmospheric pressure becomes so small that it becomes difficult to detect a pressure decrease state due to insufficiency of the refrigerant within a range of the pressure difference. In view of this, when it is determined that the outside air temperature Toutx is lower than the predetermined outside air temperature Tout1, the following steps for switching the operation mode to the determination operation mode are performed.

Refer to FIG. 2(a). Operation mode switching steps (S05 to S07) will be described. That is, in the operation mode switching steps, with the three-way valve 36 being set in such a state as to allow the heat medium heating device 32 and the heat-dissipation heat exchanger 34 to communicate with each other, the pump 31 is first started up, and the heat medium heating device 32 is turned on into a state for heating the heat medium (step S05). At this time, in the air conditioner 10, the air mix door 17 is set at the full cool position, and the blower 11 is stopped (turned off) (step S06). Thereafter, in the refrigerant cycle 20, the expansion valve 24 is made fully open to allow the refrigerant to pass therethrough without being depressurized and expanded, and the compressor 21 is started up at such a low rotational speed as to reduce the risk of early degradation in case of insufficiency of the refrigerant (step S07). The low rotational speed refers to a relatively slow rotational speed with respect to a rotational speed of the compressor 21 (rotational speed of the compression mechanism disposed inside the compressor 21) in the dehumidification operation or the cooling operation.

It is noted that at step S05, the three-way valve 36 is preferably made to disallow communication between the heat medium heating device 32 and the vehicle-cabin external heat exchanger 35. Thermal energy that has been given to the heat medium by the heat medium heating device 32 is prevented from being dissipated from the vehicle-cabin external heat exchanger 35 to an outside of the vehicle V. That is, the heat medium flowing into the refrigerant and heat-medium heat exchanger 22 is prevented from decreasing in temperature.

Thereupon, in the heat medium cycle 30, the heat medium that has been sent out of the pump 31 is heated by the heat medium heating device 32 and flows into the heat-dissipation heat exchanger 34. However, without dissipating heat in the heat-dissipation heat exchanger 34, the heat medium flows out of the heat-dissipation heat exchanger 34 and flows into the refrigerant and heat-medium heat exchanger 22. Then, the heat medium dissipates heat to the refrigerant flowing in the refrigerant cycle 20, and is thereafter sucked by the pump 31. That is, the thermal energy that has been given to the heat medium by the heat medium heating device 32 is transmitted to the refrigerant in the refrigerant and heat-medium heat exchanger 22.

Since the expansion valve 24 allows the refrigerant to pass therethrough without depressurizing and expanding the refrigerant, the compressor 21 only implements a function as a circulation pump for circulating the refrigerant in the refrigerant cycle 20. That is, because the refrigerant cycle 20 does not include a heat exchanger for positively dissipating thermal energy, the thermal energy of the heat medium heating device 32 that has been transmitted to the refrigerant via the refrigerant and heat-medium heat exchanger 22 continues to accumulate in the whole refrigerant circulating inside the refrigerant cycle 20.

Here, the refrigerant cycle 20 in the operation mode switching steps may start operating at the same time as the heat medium cycle 30. However, as illustrated in FIG. 3, preferably, the heat medium cycle 30 is first operated, and when the temperature of the heat medium is a predetermined temperature or higher, the refrigerant cycle 20 is operated.

Such an operation sequence makes it possible to efficiently enhance the refrigerant temperature, so that operation time of the refrigerant cycle 20 until a determination result of the refrigerant charge state is obtained can be shortened. This is also desirable from a viewpoint of protecting the compressor 21.

In this manner, the refrigerant temperature in the refrigerant cycle 20 can be quickly enhanced. However, in such a determination operation mode, there is no part where the refrigerant in the refrigerant cycle 20 is made to dissipate heat, and this supposedly causes a case where the refrigerant temperature increases excessively into a hazardous state. In view of this, when the refrigerant temperature increases excessively (when the refrigerant accumulates so much heat that the refrigerant temperature Tx reaches a second predetermined refrigerant temperature Tref2 or becomes higher than the second predetermined refrigerant temperature Tref2: step S08), switching to the heating operation mode (heating operation mode in the first embodiment) is performed, the compressor 21 is stopped, the air mix door 17 of the air conditioner 10 is set at the full hot position, and the blower 11 is operated (step S11). Thus, the thermal energy that has accumulated in the refrigerant is dissipated to the blown air from the heat-absorption heat exchanger 25 so as to cool the refrigerant in the refrigerant cycle 20. Moreover, the thermal energy that has been given to the heat medium is dissipated to the blown air from the heat-dissipation heat exchanger 34 so as to decrease the temperature of the heat medium that flows into the refrigerant and heat-medium heat exchanger 22, thereby reducing an amount of heat that transfers from the heat medium to the refrigerant.

In the normal determination operation mode in which such a safety function is not implemented, the refrigerant temperature is gradually enhanced by switching to the determination operation mode. Consequently, when the difference between the saturation pressure of the refrigerant and the atmospheric pressure becomes a difference enough to appropriately detect insufficiency of the refrigerant, that is, when the refrigerant temperature Tx that has been detected by the refrigerant temperature sensor 41 exceeds a first predetermined refrigerant temperature Tref1 lower than the second predetermined refrigerant temperature Tref2, it is determined whether the refrigerant is insufficient (steps S09, S10). The first predetermined refrigerant temperature Tref1 may be referred to as a determination start temperature for starting to determine whether the refrigerant is insufficient.

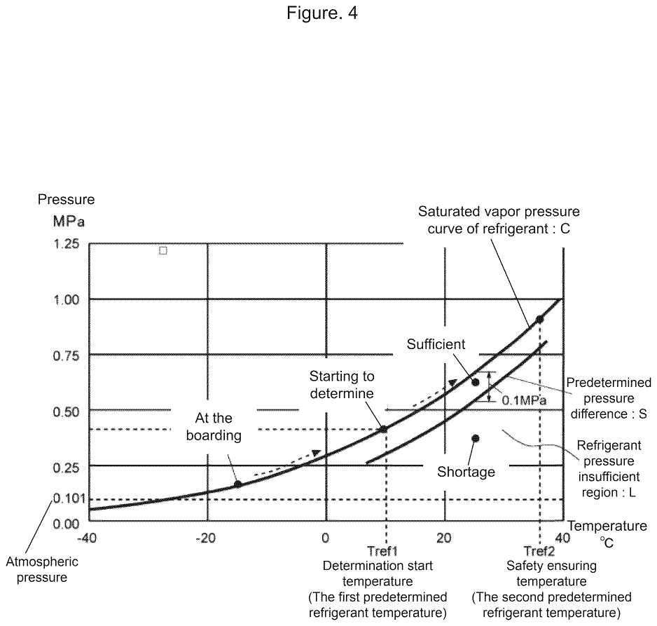

Refer to FIG. 4. Refrigerant charge state determination steps (S09 and S10) will be described. That is, in order to determine whether the refrigerant is insufficient, the refrigerant insufficiency region L is set as a temperature and pressure region that makes it possible to reliably determine a state in which the refrigerant pressure is lower than a saturation pressure due to insufficiency of the refrigerant. After the vehicle Vis boarded, the vehicular heat cycle apparatus 1 is started up to proceed to the determination operation mode. The refrigerant temperature is gradually enhanced, and after the refrigerant temperature Tx exceeds the first predetermined refrigerant temperature Tref1, a determination as to the refrigerant charge state is started (step S09). Here, the refrigerant insufficiency region L is a temperature and pressure region of the refrigerant obtained by subtracting the predetermined pressure difference S from the saturated vapor pressure curve C. As the predetermined pressure difference S, for example, a value approximately twice as large as a detection error by the refrigerant pressure sensor 42 (approximately 0.1 MPa) is applied. In the case that without considering the predetermined pressure difference S, it is determined that the refrigerant charge amount is insufficient when the refrigerant pressure Px is slightly diverged from the saturated vapor pressure curve C of the refrigerant, there is a possibility that the detection error by the refrigerant pressure sensor 42 may cause an erroneous determination to the effect that the refrigerant charge amount is insufficient although the refrigerant charge amount is actually sufficient. Then, it is determined whether the refrigerant state grasped from an actual refrigerant temperature (the refrigerant temperature Tx that has been detected by the refrigerant temperature sensor 41) and an actual refrigerant pressure (the refrigerant pressure Px that has been detected by the refrigerant pressure sensor 42) (a refrigerant state grasped by the sensors after the refrigerant temperature exceeds the first predetermined refrigerant temperature Tref1, as indicated by a black circle in FIG. 4) is in the refrigerant insufficiency region L. When the refrigerant state is in the refrigerant insufficiency region L (when the refrigerant pressure Px is lower than a pressure obtained by subtracting the predetermined pressure difference S from the saturated vapor pressure curve C), it is determined that the refrigerant charge amount in the refrigerant cycle 20 is insufficient. When the refrigerant state is not in the refrigerant insufficiency region L (when the refrigerant pressure Px is on a higher pressure side than the refrigerant insufficiency region L), it is determined that the refrigerant charge amount is sufficient (step S10).

Refer to FIG. 3. Then, when it is determined that the refrigerant charge amount is sufficient at step S10, there is no possibility of early degradation of the compressor 21 owing to insufficiency of the refrigerant. Consequently, shifting to the heating operation mode (heating operation mode in the first embodiment) is performed (step S11).

A compressor protection step (S12) will be described. In the case that it is determined that the refrigerant charge amount is insufficient, when the compressor 21 continues to be operated, there is a possibility of early degradation of the compressor 21 owing to insufficiency of the dehumidification capacity and insufficiency of a lubricant that has been intended to be collected by the compressor 21. Consequently, shifting to a compressor protection mode for stopping the compressor 21 is performed (step S12).

Thus, because the above-described determination operation mode has been introduced, even in an environment where the outside air temperature is so low that it is difficult to grasp the refrigerant charge state, heat is transferred from the heat medium to the refrigerant via the refrigerant and heat-medium heat exchanger 22, so that the refrigerant temperature (refrigerant pressure) is quickly increased to make it possible to determine the refrigerant charge state. When the refrigerant is determined to be insufficient, the compressor 21 is stopped, so that early degradation of the compressor 21 can be prevented.

### Second Embodiment

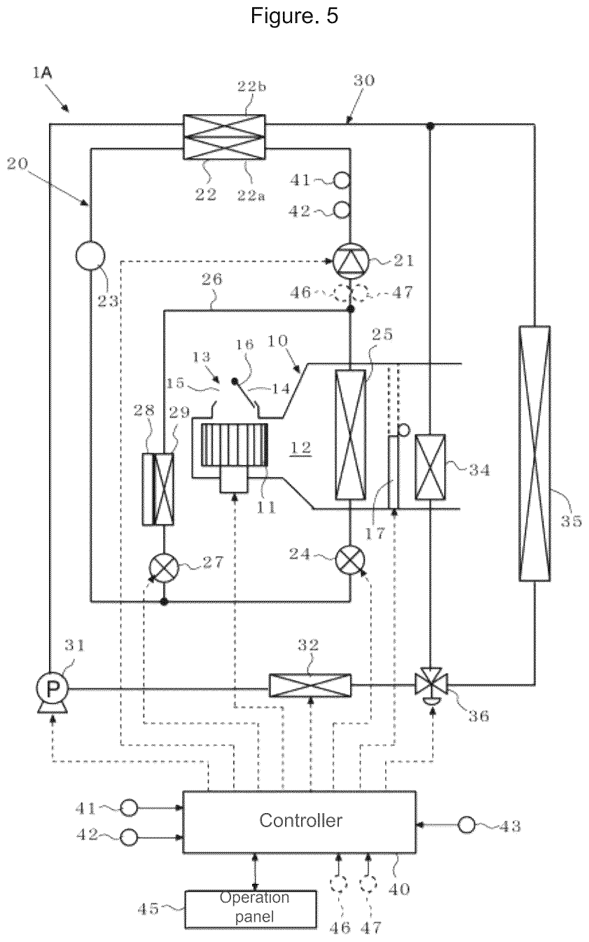

FIG. 5 illustrates a second embodiment of the vehicular heat cycle apparatus (a vehicular heat cycle apparatus 1A). In addition to the vehicular heat cycle apparatus 1 illustrated in FIG. 1, the vehicular heat cycle apparatus 1A includes a bypass passage 26 coupling a passage between an outlet portion of the refrigerant and heat-medium heat exchanger 22 and an inlet portion of the expansion valve 24 and a passage between an outlet portion of the heat-absorption heat exchanger 25 and an intake portion of the compressor 21 in the refrigerant cycle 20 to each other. On the bypass passage 26, there are further disposed a bypass-side expansion valve 27 through which the refrigerant that has flowed out of the refrigerant and heat-medium heat exchanger 22 is passable, and a bypass-side heat-absorption heat exchanger 29 into which the refrigerant that has passed through the bypass-side expansion valve 27 flows, so that the refrigerant collects heat of a heating element 28.

Here, the heating element 28 includes an inverter for controlling a drive motor, a battery used for vehicle travel, and the like. The heating element 28 is thermally coupled to the bypass-side heat-absorption heat exchanger 29 in such a manner that heat is collected by the refrigerant. Moreover, as the bypass-side expansion valve 27, not a mechanical expansion valve but an electronic expansion valve is used. An opening degree of the electronic expansion valve can be adjusted as suited by a control signal from the outside, so that the refrigerant can pass through the electronic expansion valve without being depressurized and expanded by setting the opening degree as fully open. An opening degree of the bypass-side expansion valve 27 is also controllable by the controller 40.

It is noted that because other components are substantially the same as in the first embodiment, identical components are denoted by the same reference symbols, so that descriptions thereof will be omitted.

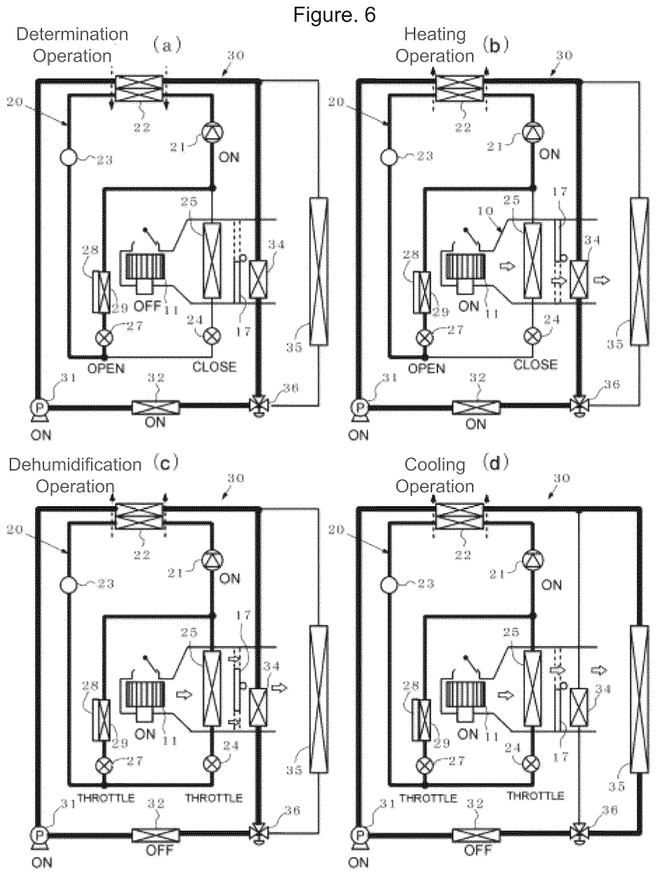

Refer to FIG. 6(b). In such a vehicular heat cycle apparatus 1A, when the operation mode is set as a heating operation mode (a heating operation mode in the second embodiment), the controller 40 turns on the compressor 21 and operates the refrigerant cycle 20. At this time, the expansion valve 24 is set to be closed, and the bypass-side expansion valve 27 is set to be fully open. The pump 31 is turned on, and the heat medium cycle 30 is operated. At this time, the heat medium is heated by turning on the heat medium heating device 32, and the three-way valve 36 is set in such a state as to allow the heat medium heating device 32 and the heat-dissipation heat exchanger 34 to communicate with each other. Further, the air mix door 17 is set at a full hot position, and the blower 11 is rotated (turned on).

Then, in the heat medium cycle 30, the heat medium that has been sent out of the pump 31 is heated by the heat medium heating device 32, and thereafter heats air blown from the blower 11 in the heat-dissipation heat exchanger 34. At this time, although the refrigerant cycle 20 is operated, the expansion valve 24 is closed. Therefore, the air blown from the blower 11 is not cooled when passing through the heat-absorption heat exchanger 25 but guided to the heat-dissipation heat exchanger 34, and after the air is heated by the heat-dissipation heat exchanger 34, the air is supplied to the vehicle cabin CR. The refrigerant flowing in the refrigerant cycle 20 passes through the bypass-side expansion valve 27 set to be fully open without being depressurized and expanded, flows into the bypass-side heat-absorption heat exchanger 29, and collects heat generated by the heating element 28. While the heating operation is being performed, the outside air temperature Toutx is low, and the temperature of the refrigerant flowing in the refrigerant cycle 20 is also low. Therefore, even when the refrigerant is not depressurized and expanded, the refrigerant can collect the heat generated by the heating element 28. Then, as time elapses, the temperature of the refrigerant gradually increases and exceeds the temperature of the heat medium in the heat medium cycle 30. The heat that has accumulated in the refrigerant is transferred to the heat medium in the heat medium cycle 30 via the refrigerant and heat-medium heat exchanger 22, and dissipated to air blown from the blower 11 via the heat-dissipation heat exchanger 34.

It is noted that in the heating operation, although not illustrated, the bypass-side expansion valve 27 may be set in a throttle state so as to adiabatically expand the refrigerant. The refrigerant that has been adiabatically expanded by the bypass-side expansion valve 27 can efficiently collect heat generated by the heating element 28 in the bypass-side heat-absorption heat exchanger 29. Also, the refrigerant is compressed to have a high temperature and a high pressure by the compressor 21 and flows into the refrigerant and heat-medium heat exchanger 22, so that the refrigerant can efficiently transmit thermal energy to the heat medium in the heat medium cycle 30.

Refer to FIG. 6(c). When the operation mode is set as the dehumidification operation mode, the controller 40 turns on the compressor 21 and operates the refrigerant cycle 20. At this time, the expansion valve 24 is set in such a throttle state as to obtain the dehumidification function, and the bypass-side expansion valve 27 is set in such a throttle state as to effectively collect heat generated by the heating element 28. The pump 31 is turned on, and the heat medium cycle 30 is operated. At this time, the heat medium heating device 32 is turned off so as not to heat the heat medium, and the three-way valve 36 is set in such a state as to allow the heat medium heating device 32 and the heat-dissipation heat exchanger 34 to communicate with each other. Further, the air mix door 17 is set at an intermediate position, and the blower 11 is rotated.

Then, in the refrigerant cycle 20, the high-temperature and high-pressure refrigerant that has been discharged from the compressor 21 dissipates heat to the heat medium in the refrigerant and heat-medium heat exchanger 22, and partly flows into the expansion valve 24 via the liquid tank 23 whereas the rest of the refrigerant flows into the bypass-side expansion valve 27. The refrigerant that has flowed into the expansion valve 24 is depressurized and expanded by the expansion valve 24. Thereafter, the refrigerant flows into the heat-absorption heat exchanger 25 and absorbs heat from the air that has been introduced into the air conditioner 10. That is, the air that has been introduced into the air conditioner 10 is dehumidified. The refrigerant that has flowed into the bypass-side expansion valve 27 is depressurized and expanded by the bypass-side expansion valve 27. Thereafter, the refrigerant collects (absorbs) heat of the heating element 28 in the bypass-side heat-absorption heat exchanger 29. The refrigerant that has flowed out of the heat-absorption heat exchanger 25 and the refrigerant that has flowed out of the bypass-side heat-absorption heat exchanger 29 join together and are sucked by the compressor 21.

In the heat medium cycle 30, the heat medium that has been sent out of the pump 31 flows into the heat-dissipation heat exchanger 34 without being heated by the heat medium heating device 32. At this time, because the heat medium has absorbed heat from the refrigerant (been heated by the refrigerant) in the refrigerant and heat-medium heat exchanger 22, the heat medium flowing into the heat-dissipation heat exchanger 34 has a constant amount of heat. Therefore, the air that has been dehumidified by passing through the heat-absorption heat exchanger 25 is partly guided to the heat-dissipation heat exchanger 34 in accordance with an opening degree of the air mix door 17 and heated whereas the rest of the air bypasses the heat-dissipation heat exchanger 34 and is mixed and sent out to the vehicle cabin CR. For example, when the air mix door 17 is made closer to a full cool position, dehumidification cooling can be performed, and when the air mix door 17 is made closer to the full hot position, dehumidification heating can be performed.

It is noted that although the heat medium is not heated by turning off the heat medium heating device 32 in the above description, the heat medium may be heated by turning on the heat medium heating device 32 so as to perform the dehumidification heating operation. Alternatively, the three-way valve 36 may be set in such a manner that the heat medium that has flowed in from the heat medium heating device 32 is made to flow into the vehicle-cabin external heat exchanger 35 in addition to the heat-dissipation heat exchanger 34 so as to perform the dehumidification cooling operation.

Refer to FIG. 6(d). When the operation mode is set as the cooling operation mode, the controller 40 turns on the compressor 21 and operates the refrigerant cycle 20. At this time, the expansion valve 24 is set in such a throttle state as to obtain a cooling function, and the bypass-side expansion valve 27 is set in such a throttle state as to effectively collect heat generated by the heating element 28. The pump 31 is turned on, and the heat medium cycle 30 is operated. At this time, the heat medium heating device 32 is turned off so as not to heat the heat medium, and the three-way valve 36 is set in such a state as to allow the heat medium heating device 32 and the vehicle-cabin external heat exchanger 35 to communicate with each other. Further, the air mix door 17 is set at the full cool position, and the blower 11 is rotated.

Then, in the refrigerant cycle 20, the high-temperature and high-pressure refrigerant that has been discharged from the compressor 21 dissipates heat to the heat medium in the refrigerant and heat-medium heat exchanger 22, and partly flows into the expansion valve 24 via the liquid tank 23 whereas the rest of the refrigerant flows into the bypass-side expansion valve 27. The refrigerant that has flowed into the expansion valve 24 is depressurized and expanded by the expansion valve 24. Thereafter, the refrigerant flows into the heat-absorption heat exchanger 25 and absorbs heat from the air that has been introduced into the air conditioner 10. That is, the air that has been introduced into the air conditioner 10 is cooled. The refrigerant that has flowed into the bypass-side expansion valve 27 is depressurized and expanded by the bypass-side expansion valve 27. Thereafter, the refrigerant collects (absorbs) heat of the heating element 28 in the bypass-side heat-absorption heat exchanger 29. The refrigerant that has flowed out of the heat-absorption heat exchanger 25 and the refrigerant that has flowed out of the bypass-side heat-absorption heat exchanger 29 join together and are sucked by the compressor 21.

Since the air mix door 17 is set at the full cool position, the air that has passed through the heat-absorption heat exchanger 25 is not heated but blown out of the air conditioner 10 so as to cool the vehicle cabin CR.

Meanwhile, in the heat medium cycle 30, the heat medium that has been sent out of the pump 31 is not heated by the heat medium heating device 32 but circulates via the vehicle-cabin external heat exchanger 35 and the refrigerant and heat-medium heat exchanger 22. After having absorbed heat from the refrigerant in the refrigerant and heat-medium heat exchanger 22, the heat medium dissipates the heat to outside air of the vehicle V in the vehicle-cabin external heat exchanger 35. That is, the heat that has been absorbed from the blown air (the air flowing in the air blowing space 12 in the air conditioner 10) by the heat-absorption heat exchanger 25 is dissipated to the atmosphere outside the vehicle V via the refrigerant and heat-medium heat exchanger 22 and the vehicle-cabin external heat exchanger 35, so that the air that has been introduced into the air conditioner 10 (the air blown from the blower 11) can be efficiently cooled.

In the above-described second embodiment, in the heating operation mode when the outside air temperature is low, the expansion valve 24 is closed, and the refrigerant cycle 20 has a cycle of the compressor 21, the refrigerant and heat-medium heat exchanger 22, the bypass-side expansion valve 27, and the bypass-side heat-absorption heat exchanger 29 in this order, so that the refrigerant cycle 20 can be operated without running the refrigerant in the heat-absorption heat exchanger 25. Consequently, while the heating operation is being performed, thermal energy can be accumulated in the refrigerant circulating in the refrigerant cycle 20. That is, the heating operation and the determination operation can be performed simultaneously.

However, when the heating operation and the determination operation are performed simultaneously, thermal energy given to the heat medium from the heat medium heating device 32 is allocated to a heat amount used for heating the blown air in the heat-dissipation heat exchanger 34 and a heat amount used for heating the refrigerant in the refrigerant and heat-medium heat exchanger 22. Therefore, when the heating operation and the determination operation are performed simultaneously, a heating capacity becomes lower than when the heating operation is solely performed, and determination time becomes longer than when the determination operation is solely performed. In view of this, it is desirable to enable the configuration to simultaneously perform the heating operation and the determination operation, and to enable the configuration to solely perform each of these operations, so that the operations are selectable in accordance with a request by a vehicle occupant.

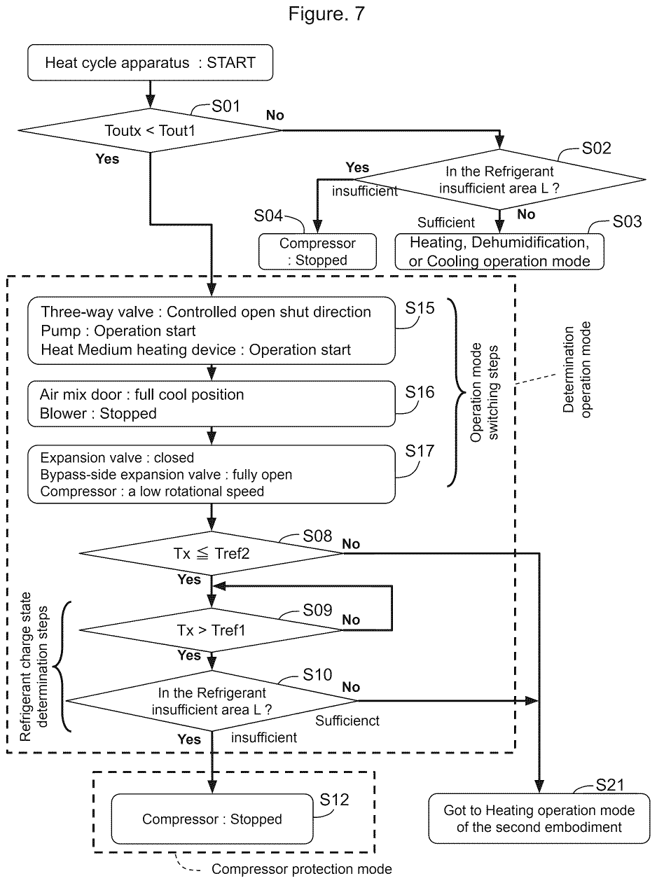

Next, a determination operation mode of the refrigerant charge state in the second embodiment will be described based on a flowchart illustrated in FIG. 7.

Step S01 to step S04 of steps in the second embodiment are substantially the same as in the first embodiment.

First, when the vehicular heat cycle apparatus 1A is starting up, the controller 40 determines whether the outside air temperature Toutx that has been detected by the outside air temperature sensor 43 is lower than the predetermined outside air temperature Tout1 (step S01).

When it is determined that the outside air temperature Toutx is the predetermined outside air temperature Tout1 or higher, the difference between the saturation pressure of the refrigerant and the atmospheric pressure is a pressure difference that makes it possible to appropriately grasp a pressure fluctuation caused by insufficiency of the refrigerant, and it is determined whether a state of the refrigerant grasped from the refrigerant temperature Tx and the refrigerant pressure Px that have been detected is diverged from the saturated vapor pressure curve C by the predetermined pressure difference S or more (i.e., whether a refrigerant state grasped is in the refrigerant insufficiency region L) so as to determine whether the refrigerant charge amount is insufficient (step S02).

As a result, when there is almost no divergence from the saturated vapor pressure curve C and when insufficiency of the refrigerant is not recognized, shifting to one of the heating operation mode, the dehumidification operation mode, and the cooling operation mode in the second embodiment is performed in accordance with a heat load inside the vehicle cabin CR (step S03). When it is determined that divergence from the saturated vapor pressure curve C is the predetermined pressure difference S or larger (when the refrigerant state grasped from the refrigerant temperature Tx and the refrigerant pressure Px is in the refrigerant insufficiency region L set on a lower pressure side than the saturated vapor pressure curve C of the refrigerant by the predetermined pressure difference S), the refrigerant charge amount in the refrigerant cycle 20 is insufficient. Consequently, when the operation is continued as it is, there is a possibility of early degradation of the compressor 21, so that the compressor 21 is stopped (step S04).

Incidentally, at step S01, when it is determined that the outside air temperature Toutx is lower than the predetermined outside air temperature Tout1 (when it is determined that the outside air temperature Toutx is less than 5° C.), the following steps for switching the operation mode to the determination operation mode are performed.

Refer to FIG. 6(a). The operation mode switching steps (S15 to S17) will be described. That is, in the operation mode switching steps, with the three-way valve 36 being set in such a state as to allow the heat medium heating device 32 and the heat-dissipation heat exchanger 34 to communicate with each other, the pump 31 is started up, and the heat medium heating device 32 is turned on to heat the heat medium (step S15). At this time, in the air conditioner 10, the air mix door 17 is set at the full cool position, and the blower 11 is stopped (turned off) (step S16). Thereafter, in the refrigerant cycle 20, the expansion valve 24 is closed to disallow the refrigerant flowing through the heat-absorption heat exchanger 25, and the bypass-side expansion valve 27 is fully opened to allow the refrigerant to pass therethrough without being depressurized and expanded, and the compressor 21 is started up at a low rotational speed to reduce the risk of early degradation in case of insufficiency of the refrigerant (step S17).

It is noted that at step S15 as well, the three-way valve 36 is preferably made to disallow communication between the heat medium heating device 32 and the vehicle-cabin external heat exchanger 35. Thermal energy that has been given to the heat medium by the heat medium heating device 32 is prevented from being dissipated from the vehicle-cabin external heat exchanger 35 to an outside of the vehicle V. That is, the heat medium flowing into the refrigerant and heat-medium heat exchanger 22 is prevented from decreasing in temperature.

Thereupon, in the heat medium cycle 30, the heat medium that has been sent out of the pump 31 is heated by the heat medium heating device 32 and flows into the heat-dissipation heat exchanger 34. However, without dissipating heat in the heat-dissipation heat exchanger 34, the heat medium flows out of the heat-dissipation heat exchanger 34 and flows into the refrigerant and heat-medium heat exchanger 22. Then, the heat medium dissipates heat to the refrigerant flowing in the refrigerant cycle 20, and is thereafter sucked by the pump 31. That is, the thermal energy that has been given to the heat medium by the heat medium heating device 32 is transmitted to the refrigerant in the refrigerant and heat-medium heat exchanger 22.

The expansion valve 24 is closed, and the bypass-side expansion valve 27 allows the refrigerant to pass therethrough without depressurizing and expanding the refrigerant, so that the compressor 21 only implements the function as a circulation pump for circulating the refrigerant in the refrigerant cycle 20. That is, because the refrigerant cycle 20 does not include a heat exchanger for positively dissipating thermal energy, the thermal energy of the heat medium heating device 32 that has been transmitted to the refrigerant via the refrigerant and heat-medium heat exchanger 22, and the thermal energy of the heating element 28 that the refrigerant has collected via the bypass-side heat-absorption heat exchanger 29 continue to accumulate in the whole refrigerant circulating inside the refrigerant cycle 20. A difference of the second embodiment from the first embodiment is that the thermal energy of the heating element 28 can be collected by the bypass-side heat-absorption heat exchanger 29, so that the thermal energy can accumulate in the refrigerant more quickly.

In this manner, the refrigerant temperature in the refrigerant cycle 20 can be quickly enhanced. However, in such a determination operation mode, there is no part where the refrigerant in the refrigerant cycle 20 is made to dissipate heat, and this supposedly causes a case where the refrigerant temperature increases excessively into a hazardous state. In view of this, when the refrigerant temperature increases excessively (when the refrigerant accumulates so much heat that the refrigerant temperature Tx reaches the second predetermined refrigerant temperature Tref2 or becomes higher than the second predetermined refrigerant temperature Tref2: step S08), switching to the heating operation mode (heating operation mode in the second embodiment) is performed (step S21). The second predetermined refrigerant temperature Tref2 may be referred to as a temperature for ensuring safety (safety ensuring temperature). Thus, the thermal energy that has been given to the heat medium is dissipated to the blown air from the heat-dissipation heat exchanger 34 so as to decrease the temperature of the heat medium that flows into the refrigerant and heat-medium heat exchanger 22, thereby reducing an amount of heat that transfers from the heat medium to the refrigerant.

In the normal determination operation mode in which such a safety function is not implemented, the refrigerant temperature is gradually enhanced by switching to the determination operation mode. Consequently, when the difference between the saturation pressure of the refrigerant and the atmospheric pressure becomes a difference enough to accurately detect insufficiency of the refrigerant, that is, when the refrigerant temperature Tx exceeds the first predetermined refrigerant temperature Tref1 lower than the second predetermined refrigerant temperature Tref2, a determination as to insufficiency of the refrigerant is performed (steps S09, S10).

This determination as to insufficiency of the refrigerant (step S10 in FIG. 7) is performed in substantially the same manner as the determination as to insufficiency of the refrigerant in the first embodiment (step S10 in FIG. 3).

Then, when it is determined that the refrigerant charge amount is sufficient at step S10, there is no possibility of early degradation of the compressor 21 owing to insufficiency of the refrigerant, and consequently, shifting to the heating operation mode (heating operation mode in the second embodiment) is performed (step S21).

A compressor protection step (S12) will be described. In the case that it is determined that the refrigerant charge amount is insufficient, when the compressor 21 continues to be operated, there is a possibility of early degradation of the compressor 21 owing to insufficiency of the dehumidification capacity and insufficiency of a lubricant that has been intended to be collected by the compressor 21. Consequently, shifting to a compressor protection mode for stopping the compressor 21 is performed (step S12).

Thus, because the above-described determination operation mode has been introduced, even in an environment where the outside air temperature is so low that it is difficult to grasp the refrigerant charge state, heat is transferred from the heat medium to the refrigerant via the refrigerant and heat-medium heat exchanger 22, so that the refrigerant temperature (refrigerant pressure) is quickly increased to make it possible to determine the refrigerant charge state. When the refrigerant is determined to be insufficient, the compressor 21 is stopped, so that early degradation of the compressor 21 can be prevented. Moreover, in the second embodiment, the determination as to insufficiency of the refrigerant can be performed while the heating operation is being performed. Therefore, when the outside air temperature is low, the heating operation of the vehicle cabin CR can be performed in parallel with the determination operation as to insufficiency of the refrigerant.

### Other Embodiments

In the first embodiment and the second embodiment, an example is described in which the refrigerant temperature sensor (refrigerant temperature detector) 41 and the refrigerant pressure sensor (refrigerant pressure detector) 42 are disposed on the high pressure side (discharge side) of the compressor 21. However, substantially the same processing may be performed using a refrigerant temperature sensor 46 and a refrigerant pressure sensor 47 that are disposed on a low pressure side (intake side) of the compressor 21. Alternatively, using the refrigerant temperature sensor 41 and the refrigerant pressure sensor 42 that are disposed on the high pressure side (discharge side) of the compressor 21 and the refrigerant temperature sensor 46 and the refrigerant pressure sensor 47 that are disposed on the low pressure side (intake side) of the compressor 21, an average temperature and an average pressure of the entire refrigerant cycle 20 may be grasped to make a determination as to the refrigerant charge state (insufficiency of the refrigerant) based on the average values. The number of the refrigerant temperature sensor (refrigerant temperature detector) 41 and the refrigerant pressure sensor (refrigerant pressure detector) 42 and positions thereof with respect to the compressor 21 are suitably selected.

### REFERENCE SIGNS LIST

1, 1A: vehicular heat cycle apparatus
10: air conditioner
11: blower
12: air blowing space
20: refrigerant cycle
21: compressor
22: refrigerant and heat-medium heat exchanger
24: expansion valve
25: heat-absorption heat exchanger
26: bypass passage
27: bypass-side expansion valve
28: heating element
29: bypass-side heat-absorption heat exchanger
30: heat medium cycle
31: pump
32: heat medium heating device
34: heat-dissipation heat exchanger
40: controller
41, 46: refrigerant temperature sensor (refrigerant temperature detector)
42, 47: refrigerant pressure sensor (refrigerant pressure detector)
43: outside air temperature sensor (outside air temperature detector)
V: vehicle
CR: vehicle cabin
S: predetermined pressure difference
L: refrigerant insufficiency region

1. A vehicular heat cycle apparatus comprising:
a refrigerant cycle inside which a refrigerant circulates and which comprises:
a compressor configured to send out the refrigerant,
a refrigerant and heat-medium heat exchanger into which the refrigerant that has been sent out of the compressor flows,
an expansion valve through which the refrigerant that has flowed out of the refrigerant and heat-medium heat exchanger is passable, and
a heat-absorption heat exchanger into which the refrigerant that has passed through the expansion valve flows;
a heat medium cycle inside which a heat medium circulates and which comprises:
a pump configured to send out the heat medium,
a heat medium heating device into which the heat medium that has been sent out of the pump flows, the heat medium heating device configured to heat the heat medium, and
a heat-dissipation heat exchanger into which the heat medium that has flowed out of the heat medium heating device flows, the heat-dissipation heat exchanger configured to dissipate heat from the heat medium, the heat medium cycle being thermally coupled to the refrigerant cycle at the refrigerant and heat-medium heat exchanger;
a refrigerant temperature detector configured to detect a temperature of the refrigerant in the refrigerant cycle;
a refrigerant pressure detector configured to detect a pressure of the refrigerant in the refrigerant cycle;
an outside air temperature detector configured to detect a temperature of outside air; and
a controller configured to control operations of the refrigerant cycle and the heat medium cycle and configured to determine a charge state of the refrigerant in the refrigerant cycle using a refrigerant temperature that has been detected by the refrigerant temperature detector, a refrigerant pressure that has been detected by the refrigerant pressure detector, and an outside air temperature that has been detected by the outside air temperature detector,
wherein the heat-absorption heat exchanger and the heat-dissipation heat exchanger are disposed in an air blowing space in an air conditioner comprising a blower,
wherein when it is determined that the outside air temperature is lower than a predetermined outside air temperature the controller is configured to switch to a determination operation mode in which the expansion valve is made fully open, and the compressor, the pump, and the heat medium heating device are operated, and
wherein after switching to the determination operation mode, when the refrigerant temperature exceeds a first predetermined refrigerant temperature the controller is configured to make a determination whether a state of the refrigerant grasped from the refrigerant temperature and the refrigerant pressure is in a refrigerant insufficiency region set on a lower pressure side than a saturated vapor pressure curve of the refrigerant by a predetermined pressure difference.

2. The vehicular heat cycle apparatus according to claim 1, wherein the controller is configured to stop the blower until the determination is completely made.

3. A vehicular heat cycle apparatus comprising:
a refrigerant cycle inside which a refrigerant circulates and which comprises:
a compressor configured to send out the refrigerant,
a refrigerant and heat-medium heat exchanger into which the refrigerant that has been sent out of the compressor flows,
an expansion valve through which the refrigerant that has flowed out of the refrigerant and heat-medium heat exchanger is passable,
a heat-absorption heat exchanger into which the refrigerant that has passed through the expansion valve flows,
a bypass passage coupling a passage between an outlet portion of the refrigerant and heat-medium heat exchanger and an inlet portion of the expansion valve to a passage between an outlet portion of the heat-absorption heat exchanger and an intake portion of the compressor,
a bypass-side expansion valve through which the refrigerant that has flowed out of the refrigerant and heat-medium heat exchanger is passable, the bypass-side expansion valve are disposed on the bypass passage. and
a bypass-side heat-absorption heat exchanger into which the refrigerant that has passed through the bypass-side expansion valve flows, so that the refrigerant is configured to collect heat of a heating element, the bypass-side heat-absorption heat exchanger are disposed on the bypass passage;
a heat medium cycle inside which a heat medium circulates and which comprises:
a pump configured to send out the heat medium,
a heat medium heating device into which the heat medium that has been sent out of the pump flows, the heat medium heating device configured to heat the heat medium, and
a heat-dissipation heat exchanger into which the heat medium that has flowed out of the heat medium heating device flows, the heat-dissipation heat exchanger configured to dissipate heat from the heat medium, the heat medium cycle being thermally coupled to the refrigerant cycle at the refrigerant and heat-medium heat exchanger;
a refrigerant temperature detector configured to detect a temperature of the refrigerant in the refrigerant cycle;
a refrigerant pressure detector configured to detect a pressure of the refrigerant in the refrigerant cycle;
an outside air temperature detector configured to detect a temperature of outside air; and
a controller configured to control operations of the refrigerant cycle and the heat medium cycle and configured to determine a charge state of the refrigerant in the refrigerant cycle using a refrigerant temperature that has been detected by the refrigerant temperature detector, a refrigerant pressure that has been detected by the refrigerant pressure detector, and an outside air temperature that has been detected by the outside air temperature detector,
wherein the heat-absorption heat exchanger and the heat-dissipation heat exchanger are disposed in an air blowing space in an air conditioner comprising a blower,
wherein when it is determined that the outside air temperature is lower than a predetermined outside air temperature the controller is configured to switch to a determination operation mode in which the expansion valve is made closed, the bypass-side expansion valve is made fully open, and the compressor, the pump, and the heat medium heating device are operated, and
wherein after switching to the determination operation mode, when the refrigerant temperature exceeds a first predetermined refrigerant temperature the controller is configured to make a determination whether a state of the refrigerant grasped from the refrigerant temperature and the refrigerant pressure is in a refrigerant insufficiency region set on a lower pressure side than a saturated vapor pressure curve of the refrigerant by a predetermined pressure difference.

4. The vehicular heat cycle apparatus according to claim 3, wherein after switching to the determination operation mode, the controller is configured to operate the blower so as to secure blown air to the heat-dissipation heat exchanger by the blower.

5. The vehicular heat cycle apparatus according to claim 1, wherein the refrigerant temperature detector and the refrigerant pressure detector are disposed on one or both of a discharge side and an intake side of the compressor.

6. The vehicular heat cycle apparatus according to claim 1, wherein the determination is made when the refrigerant cycle is operated after the heat medium cycle has been operated.

7. A method of ascertaining a refrigerant charge state using a vehicular heat cycle apparatus comprising:
a refrigerant cycle inside which a refrigerant circulates and which comprises:
a compressor configured to send out the refrigerant,
a refrigerant and heat-medium heat exchanger into which the refrigerant that has been sent out of the compressor flows,
an expansion valve through which the refrigerant that has flowed out of the refrigerant and heat-medium heat exchanger is passable, and
a heat-absorption heat exchanger into which the refrigerant that has passed through the expansion valve flows;
a heat medium cycle inside which a heat medium circulates and which comprises:
a pump configured to send out the heat medium,
a heat medium heating device into which the heat medium that has been sent out of the pump flows, the heat medium heating device configured to heat the heat medium, and
a heat-dissipation heat exchanger into which the heat medium that has flowed out of the heat medium heating device flows, the heat-dissipation heat exchanger configured to dissipate heat from the heat medium, the heat medium cycle being thermally coupled to the refrigerant cycle at the refrigerant and heat-medium heat exchanger;
a refrigerant temperature detector configured to detect a temperature of the refrigerant in the refrigerant cycle;
a refrigerant pressure detector configured to detect a pressure of the refrigerant in the refrigerant cycle;
an outside air temperature detector configured to detect a temperature of outside air; and
a controller configured to control operations of the refrigerant cycle and the heat medium cycle and configured to determine a charge state of the refrigerant in the refrigerant cycle using a refrigerant temperature that has been detected by the refrigerant temperature detector, a refrigerant pressure that has been detected by the refrigerant pressure detector, and an outside air temperature that has been detected by the outside air temperature detector,
wherein the heat-absorption heat exchanger and the heat-dissipation heat exchanger are disposed in an air blowing space in an air conditioner comprising a blower,
the method of ascertaining a refrigerant charge state comprising:
operation mode switching steps of, when it is determined that the outside air temperature is lower than a predetermined outside air temperature switching to a determination operation mode in which the expansion valve is made fully open, and the compressor, the pump, and the heat medium heating device are operated, and
refrigerant charge state determination steps of, after switching to the determination operation mode, when the refrigerant temperature exceeds a first predetermined refrigerant temperature determining a divergence degree of an actual pressure of the refrigerant with respect to a saturation pressure of the refrigerant at the temperature, so as to make a determination from the divergence degree as to whether the refrigerant in the refrigerant cycle is insufficient.

8. A method of ascertaining a refrigerant charge state using a vehicular heat cycle apparatus comprising:
a refrigerant cycle inside which a refrigerant circulates and which comprises:
a compressor configured to send out the refrigerant,
a refrigerant and heat-medium heat exchanger into which the refrigerant that has been sent out of the compressor flows,
an expansion valve through which the refrigerant that has flowed out of the refrigerant and heat-medium heat exchanger is passable,
a heat-absorption heat exchanger into which the refrigerant that has passed through the expansion valve flows,
a bypass passage coupling a passage between an outlet portion of the refrigerant and heat-medium heat exchanger and an inlet portion of the expansion valve to a passage between an outlet portion of the heat-absorption heat exchanger and an intake portion of the compressor,
a bypass-side expansion valve through which the refrigerant that has flowed out of the refrigerant and heat-medium heat exchanger is passable, the bypass-side expansion valve are disposed on the bypass passage, and
a bypass-side heat-absorption heat exchanger into which the refrigerant that has passed through the bypass-side expansion valve flows, so that the refrigerant is configured to collect heat of a heating element, the bypass-side heat-absorption heat exchanger are disposed on the bypass passage;
a heat medium cycle inside which a heat medium circulates and which comprises:
a pump configured to send out the heat medium,
a heat medium heating device into which the heat medium that has been sent out of the pump flows, the heat medium heating device configured to heat the heat medium, and
a heat-dissipation heat exchanger into which the heat medium that has flowed out of the heat medium heating device flows, the heat-dissipation heat exchanger configured to dissipate heat from the heat medium, the heat medium cycle being thermally coupled to the refrigerant cycle at the refrigerant and heat-medium heat exchanger;
a refrigerant temperature detector configured to detect a temperature of the refrigerant in the refrigerant cycle;
a refrigerant pressure detector configured to detect a pressure of the refrigerant in the refrigerant cycle;
an outside air temperature detector configured to detect a temperature of outside air; and
a controller configured to control operations of the refrigerant cycle and the heat medium cycle and configured to determine a charge state of the refrigerant in the refrigerant cycle using a refrigerant temperature that has been detected by the refrigerant temperature detector, a refrigerant pressure that has been detected by the refrigerant pressure detector, and an outside air temperature that has been detected by the outside air temperature detector,
wherein the heat-absorption heat exchanger and the heat-dissipation heat exchanger are disposed in an air blowing space of an air conditioner comprising a blower,
the method of ascertaining a refrigerant charge state comprising:
operation mode switching steps of, when it is determined that the outside air temperature is lower than a predetermined outside air temperature switching to a determination operation mode in which the expansion valve is made closed, the bypass-side expansion valve is made fully open, and the compressor, the pump, and the heat medium heating device are operated, and
refrigerant charge state determination steps of, after switching to the determination operation mode, when the refrigerant temperature exceeds a first predetermined refrigerant temperature determining a divergence degree of an actual pressure of the refrigerant with respect to a saturation pressure of the refrigerant at the temperature, so as to make a determination from the divergence degree as to whether the refrigerant in the refrigerant cycle is insufficient.

9. The method of ascertaining a refrigerant charge state according to claim further comprising a compressor protection step of, when it is determined from the refrigerant charge state determination steps that the refrigerant cycle has refrigerant insufficiency, switching to a compressor protection mode of protecting the compressor by stopping the compressor.
